(19) United States
(12) Patent Application Publication
(10) Pub. No.: US 2026/0302596 A1
(43) Pub. Date: Oct. 1, 2026

(54) NEAR FIELD COMMUNICATION ANTENNA

(71) Applicant: Garmin International, Inc., Olathe, KS (US)

(72) Inventors: Anup N. Kulkarni, Olathe, KS (US); Scot Ford, Olathe, KS (US)

(21) Appl. No.: 19/370,993

(22) Filed: Oct. 28, 2025

Related U.S. Application Data
(60) Provisional application No. 63/777,384, filed on Mar. 25, 2025.

(51) Int. Cl. H01Q 1/22; H01Q 9/04

(52) U.S. Cl. CPC H01Q 1/2291; H01Q 9/0414

(57) ABSTRACT

A near field communications (NFC) antenna comprises a multi-layer circuit substrate and first, second, and third antenna segments. The circuit substrate includes a plurality of spaced apart electrically conductive layers formed from an electrically conductive material and a plurality of electrically conductive vias which electrically connect a respective one of the electrically conductive layers to one or more other electrically conductive layers. The first antenna segment is formed on a first electrically conductive layer. The second antenna segment is formed on a second electrically conductive layer and is electrically connected to the first antenna segment by a first via. The third antenna segment is formed on a third electrically conductive layer, the third antenna segment electrically connected to the second antenna segment by a second via.

### RELATED APPLICATIONS

The current patent application is a non-provisional utility patent application which claims priority benefit, with regard to all common subject matter, under 35 U.S.C. § 119(e) of earlier-filed U.S. Provisional Application Ser. No. 63/777,384, entitled “WATCH HOUSING HAVING A RECEIVING STRUCTURE AND OUTER STRUCTURE ELEMENTS,” and filed Mar. 25, 2025. The Provisional Application is hereby incorporated by reference, in its entirety, into the current patent application.

### BACKGROUND

Near field communication (NFC) is a short-range wireless radio frequency (RF) technology that allows electronic devices to communicate with each other at small distances, typically within a few centimeters. It’s commonly used for contactless payments, data exchange, support wireless connections between electronic devices such as wearables and smartphones, providing RF identification (RFID) communication, and so forth. NFC enables a variety of functions, including paying for purchases, sharing files, and automating tasks.

### SUMMARY

Embodiments of the present technology provide a near field communication (NFC) antenna that has an inductive coil configuration distributed on a plurality of spaced apart layers. The antenna broadly comprises a multi-layer circuit substrate, a first antenna segment, a second antenna segment, and a third antenna segment. The multi-layer circuit substrate includes a plurality of spaced apart electrically conductive layers formed from an electrically conductive material and a plurality of electrically conductive vias which electrically connect a respective one of the electrically conductive layers to one or more other electrically conductive layers. The first antenna segment is formed on a first electrically conductive layer of the plurality of spaced apart electrically conductive layers. The second antenna segment is formed on a second electrically conductive layer of the plurality of spaced apart electrically conductive layers and is electrically connected to the first antenna segment by a first via. The third antenna segment is formed on a third electrically conductive layer of the plurality of spaced apart electrically conductive layers, the third antenna segment electrically connected to the second antenna segment by a second via.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present technology will be apparent from the following detailed description of the embodiments and the accompanying drawing figures.

### BRIEF DESCRIPTION OF DRAWINGS

Embodiments of the present technology are described in detail below with reference to the attached drawing figures, wherein:

FIG. 1 is a block schematic diagram of a near field communication (NFC) antenna, constructed in accordance with various embodiments of the present technology, electrically connected to a communications transceiver;

FIG. 2 is a top plan view of the NFC antenna of the FIG. 1, illustrating a multi-layer circuit substrate including an (electrically) conductive layer a plurality of vias (two vias positioned on the conductive layer upper layer and six vias positioned on (electrically) insulating layers of the multi-layer circuit substrate below the upper layer), and one of a plurality of antenna segments of the NFC antenna;

FIGS. 3A, 3B, 3C, 3D, 3E, 3F, and 3G, each show an upper perspective view of the first through seventh (electrically) conductive layers, respectively, of the multi-layer circuit substrate, illustrating a respective one of the plurality of antenna segments of the NFC antenna;

FIG. 3H is a lower perspective view of the eighth conductive layer of the multi-layer circuit substrate, illustrating an eighth antenna segment of the NFC antenna;

FIG. 4 is a block schematic diagram of another embodiment of the NFC antenna electrically connected to a communications transceiver;

FIG. 5 is a top plan view of the NFC antenna of FIG. 4, illustrating a multi-layer circuit substrate including an (electrically) conductive layer a plurality of vias (two vias positioned on the conductive layer upper layer and twelve vias positioned on (electrically) insulating layers of the multi-layer circuit substrate below the upper layer), one of a plurality of outer antenna segments of the NFC antenna, and one of a plurality of inner antenna segments of the NFC antenna;

FIGS. 6A, 6B, 6C, 6D, 6E, 6F, and 6G, each show an upper perspective view of the first through seventh (electrically) conductive layers, respectively, of the multi-layer circuit substrate, illustrating a respective one of the plurality of outer antenna segments of the NFC antenna and a respective one of the inner antenna segments of the NFC antenna; and

FIG. 6H is a lower perspective view of the eighth conductive layer of the multi-layer circuit substrate, illustrating an eighth outer antenna segment and an eighth inner antenna segment of the NFC antenna.

The drawing figures do not limit the present technology to the specific embodiments disclosed and described herein. The drawings are not necessarily to scale, emphasis instead being placed upon clearly illustrating the principles of the technology.

### DETAILED DESCRIPTION OF THE TECHNOLOGY

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the present technology. The following detailed description is, therefore, not to be taken in a limiting sense. The scope of the present technology is defined only by the appended claims, along with the full scope of equivalents to which such claims are entitled.

Relational and/or directional terms, such as “above”, “below”, “up”, “upper”, “upward”, “down”, “lower”, “downward”, “top”, “bottom”, “outer”, “inner”, “left”, “right”, “front”, “rear”, “fore”, “aft”, “forward”, “rearward”, etc., along with orientation terms, such as “horizontal” and “vertical”, may be used throughout this description. These terms retain their commonly accepted definitions and are used with reference to embodiments of the technology and the positions, directions, and orientations thereof shown in the accompanying figures. However, embodiments of the technology in practice may be positioned and oriented in other ways or move in other directions. Therefore, the terms do not limit the scope of the current technology.

Handheld electronic devices including smartphones, wrist worn electronic devices including smart watches, and the like, often include near field communication (NFC) capabilities. To provide NFC capabilities, each electronic device may include a communications transceiver configured to transmit and receive electronic signals and an NFC antenna which is in electronic communication with (electrically connected to or electrically coupled with) the communications transceiver. The NFC antenna converts electronic signals from the communications transceiver into corresponding wireless signals transmitted by the electronic device. The NFC antenna of the electronic device also receives wireless signals that it converts into electronic signals communicated to the communications transceiver.

Traditionally, NFC antennas have been implemented on a single plane or a single electrically conductive layer of a circuit substrate, such as a printed circuit board, as a single electrically conductive signal trace having a coil shape along a single plane or two planes. For instance, a first end of the signal trace may start near one edge of the substrate and extend along the perimeter in a circular or rectangular fashion forming a loop with each turn that gradually moves inward each time the loop is formed to result in the signal trace having a coil shape. In some cases, after a certain number of loops or turns have been formed on a first plane, the signal trace shifts to a second layer on a second plane, which may be positioned either above or below the first layer, with the ends of the signal trace on a common edge such that a first end and a second end of the signal trace are positioned adjacent to one another. A drawback to the planar coil implementation of conventional NFC antennas is that a lot of surface area of the substrate is required and that requirement can make the substrate onto which the signal trace is positioned larger than desired. Given that the NFC antenna may be implemented in smaller devices, such as smart watches, NFC antennas that consume less space are desirable.

The NFC antenna of the current technology provides a discrete layer inductive coil antenna that is implemented on multiple (electrically) conductive layers of a circuit substrate, such as a rigid printed circuit board, flexible printed circuitry, or a combination thereof. The NFC antenna includes a plurality of antenna segments, wherein each antenna segment embodies a respective one of the substantial loops or turns that collectively form the multi-planar coil. Each antenna segment includes, or is formed by, one or more (electrically conductive) signal traces on a respective conductive layer of the circuit substrate. The antenna segment on one conductive layer of the multi-layer circuit substrate is electrically connected to the antenna segments on other conductive layers of the multi-layer circuit substrate through a plurality of (electrically conductive) vias that electrically couple the signal traces on each conductive layer. Furthermore, in embodiments, the antenna segment on one conductive layer of the multi-layer circuit substrate is substantially vertically aligned with the antenna segments on other conductive layers of the multi-layer circuit substrate. This vertically aligned coil configuration of the current technology allows for the collective signal traces of the NFC antenna to utilize less surface area than traditional planar NFC antennas having the same or a similar total length. Accordingly, the total length of the plurality of antenna segments may be increased without increasing the surface area of each electrically conductive layer on which the signal trace is positioned.

Embodiments of the technology will now be described in more detail with reference to the drawing figures. Referring initially to FIGS. 1-3H, an NFC antenna 10 is illustrated. The NFC antenna 10 is an inductive coil antenna that transmits and receives radio frequency (RF) wireless signals. As shown in FIG. 1, in a typical usage scenario shown schematically, the NFC antenna 10 is in electronic communication with (electrically connected to or electrically coupled with) a communications transceiver 100. When receiving wireless signals, the NFC antenna 10 converts the received wireless signal into a corresponding electronic signal that is communicated to the communications transceiver 100. When transmitting wireless signals, the NFC antenna 10 receives an electronic signal from the communications transceiver 100, which is converted to a corresponding wireless signal that is transmitted.

The communications transceiver 100 is configured to process electronic signals communicated to and from the NFC antenna 10. The communication transceiver 100 may include electronic circuit components such as single-stage or multi-stage amplifiers, low pass, high pass, band pass, or band notch filters, analog to digital converters (ADCs), digital to analog converters (DACs), and so forth. The communications transceiver 100 may further include electronic signal processors such as digital signal processors (DSPs), microprocessors, microcontrollers, and the like.

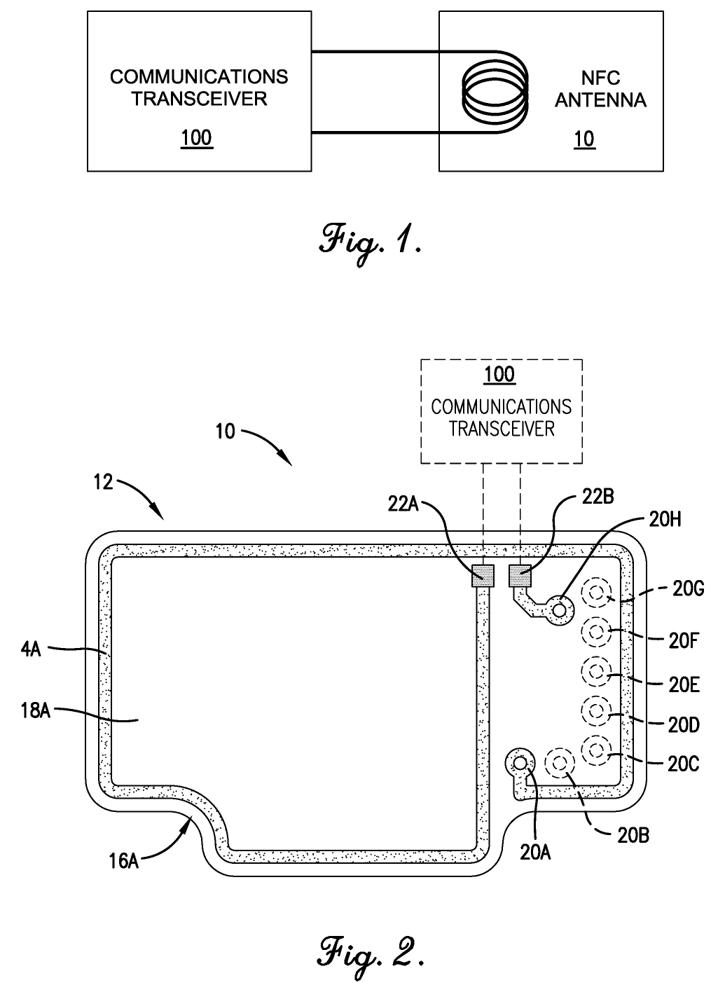

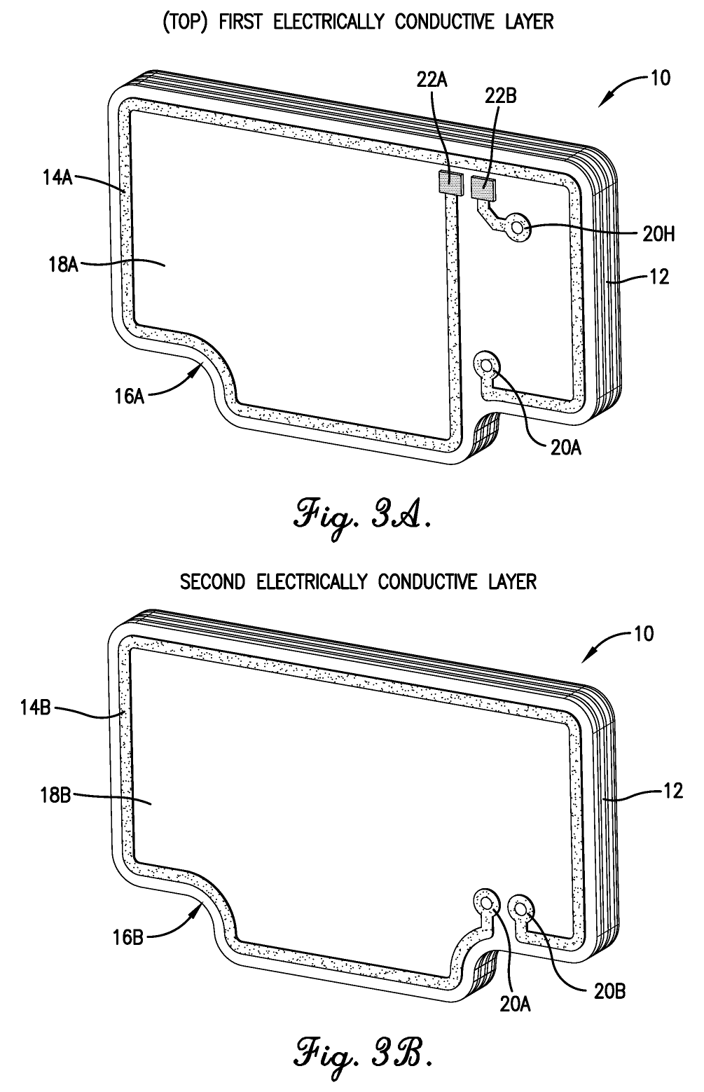

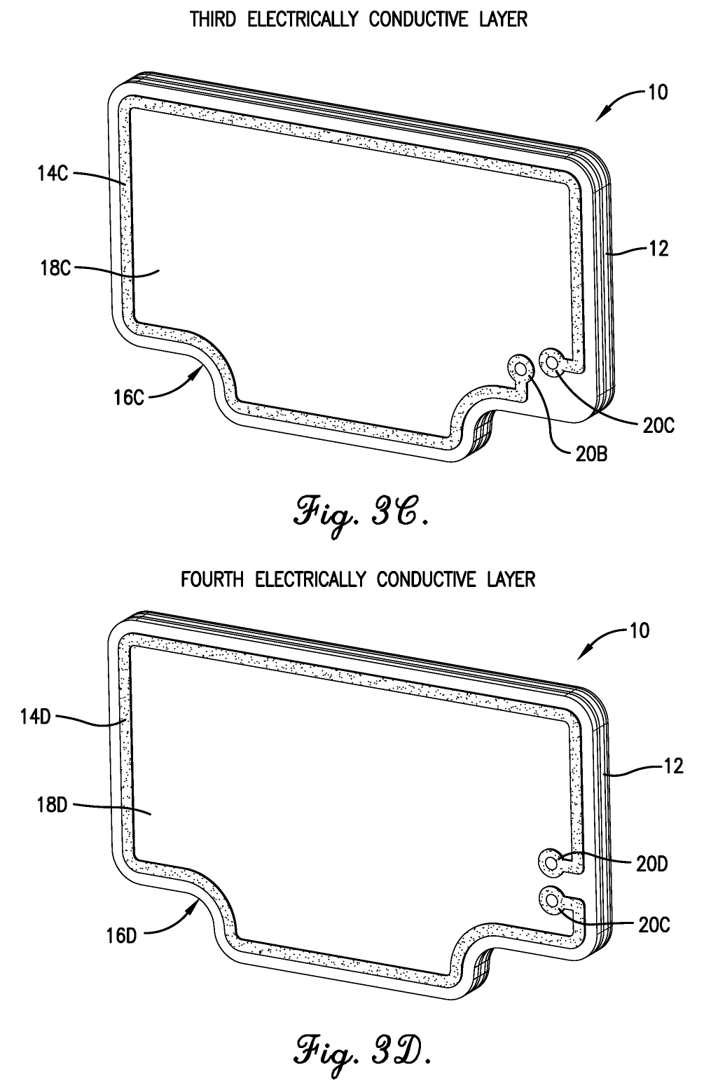

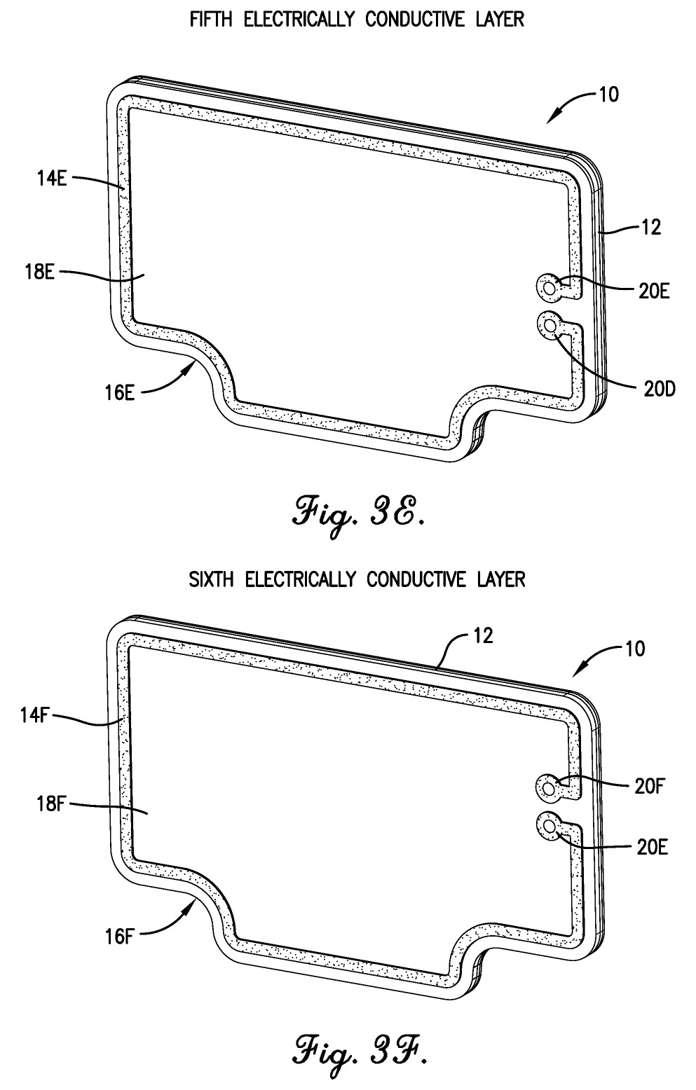

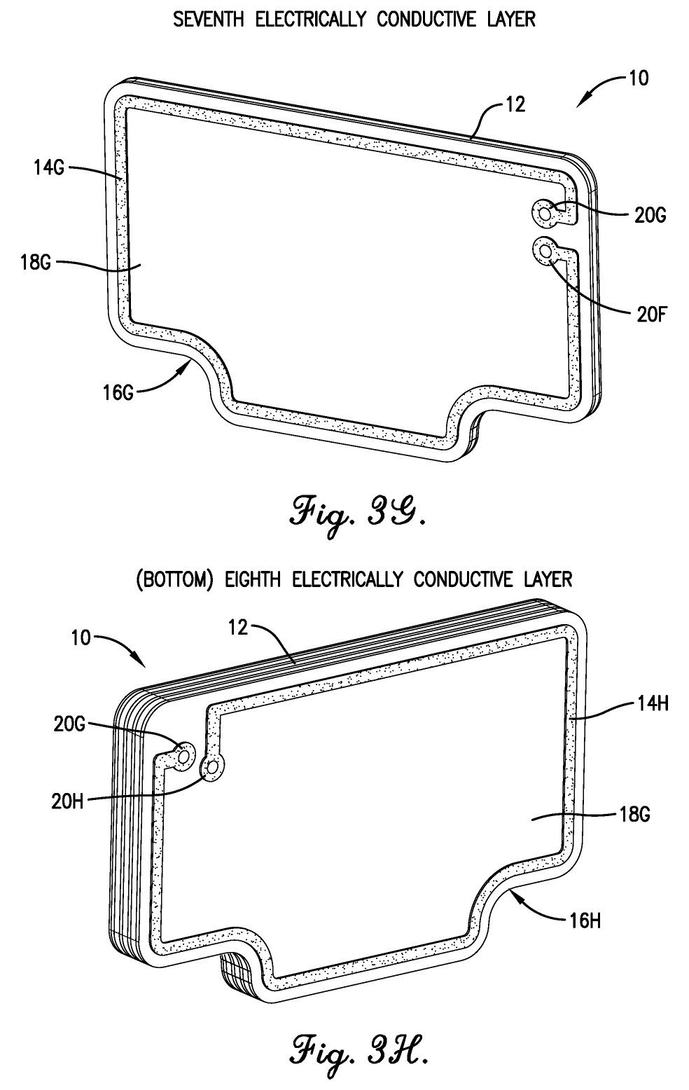

A physical construction of one embodiment of the NFC antenna 10 is shown in FIGS. 2 and 3A-3H. Exemplary embodiments of the NFC antenna 10 include eight (8) conductive layers 16A, 16B, 16C, 16D, 16E, 16F, 16G, 16H, and seven (7) insulating layers 18A, 18B, 18C, 18D, 18E, 18F, 18G. In some embodiments, a number of the conductive layers 16 may vary according to a number of antenna segments 14, as discussed below. Accordingly, exemplary embodiments of the NFC antenna 10 include the top conductive layer 16A, six (6) inner conductive layers 16B, 16C, 16D, 16E, 16F, 16G, and the bottom conductive layer 16H, separated by the top insulating layer 18A, five (5) inner insulating layers 18B, 18C, 18D, 18E, 18F, and a bottom insulating layer 18G.

The NFC antenna 10 broadly comprises a multi-layer circuit substrate 12 and a plurality of antenna segments 14. One or more electrical components may be positioned on an exterior surface (e.g., on the top insulating layer 18A, below the bottom conductive layer 16H, etc.) or within the multi-layer circuit substrate 12 (e.g., between the top conductive layer 16A and the second conductive layer 16B, between the top conductive layer 16A and the bottom conductive layer 16H, etc.) between the plurality of antenna segments 14. For instance, in some embodiments, one or more light emitting diodes (LEDs), a camera device and/or a vibration motor used for providing haptic feedback may be positioned on an exterior surface of the multi-layer circuit substrate 12, such as a top insulating layer 18A. In embodiments, a ferrite sheet may be positioned on or proximate to an exterior surface of the multi-layer circuit substrate 12 and the plurality of antenna segments 14 to improve the performance of the NFC antenna 10, typically in the direction opposing the ferrite sheet. For instance, the ferrite sheet may be positioned on the top insulating layer 18A and the performance of the NFC antenna 10 may be improved below the bottom conductive layer 16H. Similarly, the ferrite sheet may be positioned on a left side of the multi-layer circuit substrate 12 and the performance of the NFC antenna 10 may be improved on the right side of the multi-layer circuit substrate 12.

The circuit substrate 12 may be embodied by a printed circuit board, typically formed from rigid materials, such as fiberglass, by flexible printed circuitry, typically formed from non-rigid polymer materials, or a combination thereof. Other substrate technologies may also be utilized. The circuit substrate 12 includes a plurality of spaced-apart (electrically) conductive layers 16, a plurality of spaced-apart (electrically) insulating layers 18, and a plurality of vias 20 extending therebetween. The conductive layers 16 are each formed from metals, such as copper, and/or metal alloys, and include a top conductive layer 16, a plurality of inner conductive layers 16, and a bottom conductive layer 16. Each conductive layer 16 may accommodate or include one or more electrically conductive features, such as electronic signal traces, electric power or ground traces, one or more signal, power, or ground pads, surface-mount or through-hole component pads, surface-mount or through-hole integrated circuit package footprints, full or partial power planes, or full or partial ground planes, and the like.

The insulating layers 18 are each formed from insulators or dielectrics such as fiberglass, woven glass, matte glass, cotton paper, phenolic cotton paper, epoxies, epoxy resins, polyester (PET), polyimide (PI), polyethylene naphthalate (PEN), polyetherimide (PEI), along with various fluoropolymer (FEP) and copolymers, and so forth. The insulating layers 18 include a top insulating layer 18, a plurality of inner insulating layers 18, and a bottom insulating layer 18.

Each insulating layer 18 is positioned between a respective pair of adjacent conductive layers 16 such that the combination of the conductive layers 16 and the insulating layers 18 forms a stack, with a first, top conductive layer 16 at the top of the stack and a last, bottom conductive layer 16 at the bottom of the stack of electrically conductive layers 16 and electrically insulating layers 18. In addition, each conductive layer 16 is positioned on, adhered to, and in contact with, an upper surface and/or a lower surface of a respective one or more of the insulating layers 18. Thus, the top conductive layer 16 is positioned on the upper surface of the top insulating layer 18. Each inner conductive layer 16 is positioned on the lower surface of the top insulating layer 18 and the upper surface of one of the inner insulating layers 18, the lower surface of one of the inner insulating layers 18 and the upper surface of an adjacent inner insulating layers 18, or the lower surface of one of the inner insulating layers 18 and the upper surface of the bottom insulating layer 18. And, the bottom conductive layer 16 is positioned on the lower surface of the bottom insulating layer 18.

Each via 20 provides electrical connection from or electrical coupling between one or more components, signal traces, or electric power or ground planes on a respective one of the conductive layers 16 to one or more components, signal traces, or electric power or ground planes on one or more of the other conductive layers 16. Each via 20 consists of or includes electrically conductive material (metals and/or metal alloys) and is positioned within and passes through an opening in one or more of the insulating layers 18 to provide an electrical connection from or electrical coupling between two signal traces on positioned on separated conductive layers 16. The vias 20 may include blind vias, buried vias, or through substrate vias. Exemplary embodiments of the NFC antenna 10 include eight (8) vias 20A, 20B, 20C, 20D, 20E, 20F, 20G, 20H.

Each antenna segment 14 is a respective one of a plurality of antenna segments 14 collectively forming the NFC antenna 10 and is formed on a respective one of the plurality of conductive layers 16. Exemplary embodiments of the NFC antenna 10 include eight (8) antenna segments 14A, 14B, 14C, 14D, 14E, 14F, 14G, 14H and vias 20A-20H therebetween. In embodiments, each antenna segment 14A-14H is of a substantially equal length. In other embodiments, each antenna segment 14A-14H has a different length. Accordingly, a number of antenna segments 14 and the length of each antenna segment may vary according to a desired total length of the NFC antenna 10, which in turn, may vary according to, or be proportional to, a desired wavelength, or a portion thereof, such as a half wavelength or a quarter wavelength, of the wireless signal that the NFC antenna 10 is to transmit and/or receive. For instance, the total desired length of the NFC antenna 10 may be selected based on a desired impedance for an application of electric current, such as 8 Ohms or 10 Ohms, a characteristics of the communications transceiver 100 or a desired inductance (e.g., in the magnitude of 1 micro-Henry (µH)). Once a total length of the NFC antenna 10 is determined, the number of antenna segments 14 and the length of each antenna segment 14 may be determined. For example, in embodiments having antenna lengths of substantially equal length, the length of each antenna segment 14 may be determined by dividing the total desired length of the NFC antenna 10 by the number of antenna segments 14. In addition, each antenna segment 14 includes, or is formed by, a respective one of the plurality of signal traces – although other embodiments of the antenna segments 14 may include more than one signal trace.

Each antenna segment 14 is electrically connected to or electrically coupled with its successive antenna segment 14 through a respective one of the vias 20. For example, the first antenna segment 14A is electrically connected to the second antenna segment 14B through the first via 20A, the second antenna segment 14B is electrically connected to the third antenna segment 14C through the second via 20B, and so forth, with successive antenna segments 14 including the seventh antenna segment 14G being electrically connected to the eighth antenna segment 14H through the seventh via 20G.

Referring to FIG. 2, a plan view of the NFC antenna 10 is shown, illustrating the first antenna segment 14A positioned on the (top) first insulating layer 18A. Also shown are the first through eighth vias 20A-20H, with the second via through seventh via 20B, 20C, 20D, 20E, 20F, 20G being shown in dashed lines to indicate their position within the circuit substrate 12 – given that they may be implemented as internal vias that are not visible from the upper surface of the first insulating layer 18A. In addition, the NFC antenna 10 includes a first terminal 22A and a second terminal 22B that provide contacts for the NFC antenna 10 to be electrically connected to other components, such as a communications transceiver 100, as shown in FIG. 2. A first end of the first antenna segment 14A is electrically connected to the first via 20A, and a second end of the first antenna segment 14A is electrically connected to the first terminal 22A. The second terminal 22B is electrically connected to the eighth via 20H through one of the signal traces. The first terminal 22A and the second terminal 22B are typically located adjacent to the edge or perimeter of the first conductive layer 16A, which may enable more ease of electrically connecting or electrically coupling the NFC antenna 10 with other components, such as a communications transceiver 100, through a cable, electrical pin header connectors, a socket connector, or the like, or combinations thereof.

Referring to FIGS. 3A-3H, a perspective view of each of the conductive layers 16 and the respective associated antenna segment 14 is shown. Referring to FIG. 3A, the first antenna segment 14A on the first conductive layer 16A (that is positioned above the upper surface of the first insulating layer 18A), the first via 20A and the eighth via 20H, along with the first terminal 22A and the second terminal 22B are shown. Referring to FIG. 3B, the second antenna segment 14B on the second conductive layer 16B (that is between the upper surface of the second insulating layer 18B and the lower surface of the first insulating layer 18A) is shown. A first end of the second antenna segment 14B is electrically connected to the first via 20A, and a second end is electrically connected to the second via 20B. Accordingly, the first antenna segment 14A is electrically connected to and electrically coupled with the second antenna segment 14B through the first via 20A. Referring to FIG. 3C, the third antenna segment 14C on the third conductive layer 16C (that is between the upper surface of the third insulating layer 18C and the lower surface of the second insulating layer 18B) is shown. A first end of the third antenna segment 14C is electrically connected to the second via 20B, and a second end is electrically connected to the third via 20C. Accordingly, the second antenna segment 14B is electrically connected to and electrically coupled with the third antenna segment 14C through the second via 20B. Referring to FIG. 3D, the fourth antenna segment 14D on the fourth conductive layer 16D (that is between the upper surface of the fourth insulating layer 18D and the lower surface of the third insulating layer 18C) is shown. A first end of the fourth antenna segment 14D is electrically connected to the third via 20C, and a second end is electrically connected to the fourth via 20D. Accordingly, the third antenna segment 14C is electrically connected to and electrically coupled with the fourth antenna segment 14D through the third via 20C. Referring to FIG. 3E, the fifth antenna segment 14E on the fifth conductive layer 16E (that is between the upper surface of the fifth insulating layer 18E and the lower surface of the fourth insulating layer 18D) is shown. A first end of the fifth antenna segment 14E is electrically connected to the fourth via 20D, and a second end is electrically connected to the fifth via 20E. Accordingly, the fourth antenna segment 14D is electrically connected to and electrically coupled with the fifth antenna segment 14E through the fourth via 20D. Referring to FIG. 3F, the sixth antenna segment 14F on the sixth conductive layer 16F (that is between the upper surface of the sixth insulating layer 18F and the lower surface of the fifth insulating layer 18E) is shown. A first end of the sixth antenna segment 14F is electrically connected to the fifth via 20E, and a second end is electrically connected to the sixth via 20F. Accordingly, the fifth antenna segment 14E is electrically connected to and electrically coupled with the sixth antenna segment 14F through the fifth via 20E. Referring to FIG. 3G, the seventh antenna segment 14G on the seventh conductive layer 16G (that is between the upper surface of the seventh insulating layer 18G and the lower surface of the sixth insulating layer 18F) is shown. A first end of the seventh antenna segment 14G is electrically connected to the sixth via 20F, and a second end is electrically connected to the seventh via 20G. Accordingly, the sixth antenna segment 14F is electrically connected to and electrically coupled with the seventh antenna segment 14G through the sixth via 20F. Referring to FIG. 3H, the eighth antenna segment 14H on the eighth conductive layer 16H (positioned on the lower surface of the seventh insulating layer 18G) is shown. A first end of the eighth antenna segment 14H is electrically connected to the seventh via 20G, and a second end is electrically connected to the eighth via 20H, which extends up to the first conductive layer 16A through conductive layers 16A-16H and insulating layers 18A-18F to the upper surface of the first conductive layer 16A. Each antenna segment 14 generally extends along a perimeter, or the edges, of the insulating layers 18 of the circuit substrate 12.

In other embodiments, the NFC antenna 10 may be implemented with three antenna segments 14, each on a respective one of three conductive layers 16, and including two vias 20. For example, a first end of a first antenna segment 14A on a first conductive layer 16A is electrically connected to a first via 20A and a second end of the first antenna segment 14A is electrically connected to a first terminal 22A. A first end of a second antenna segment 14B on a second conductive layer 16B is electrically connected to the first via 20A, which electrically couples the second antenna segment 14B with the first antenna segment 14A. A second end of the second antenna segment 14B is electrically connected to a second via 20B. A first end of a third antenna segment 14C on a third conductive layer 16C is electrically connected to the second via 20A, which electrically couples the third antenna segment 14C with the second antenna segment 14B. A second end of the third antenna segment 14C is electrically connected to a third via 20C. The third via 20C is also electrically connected to a second terminal 22B on the first conductive layer 16A.

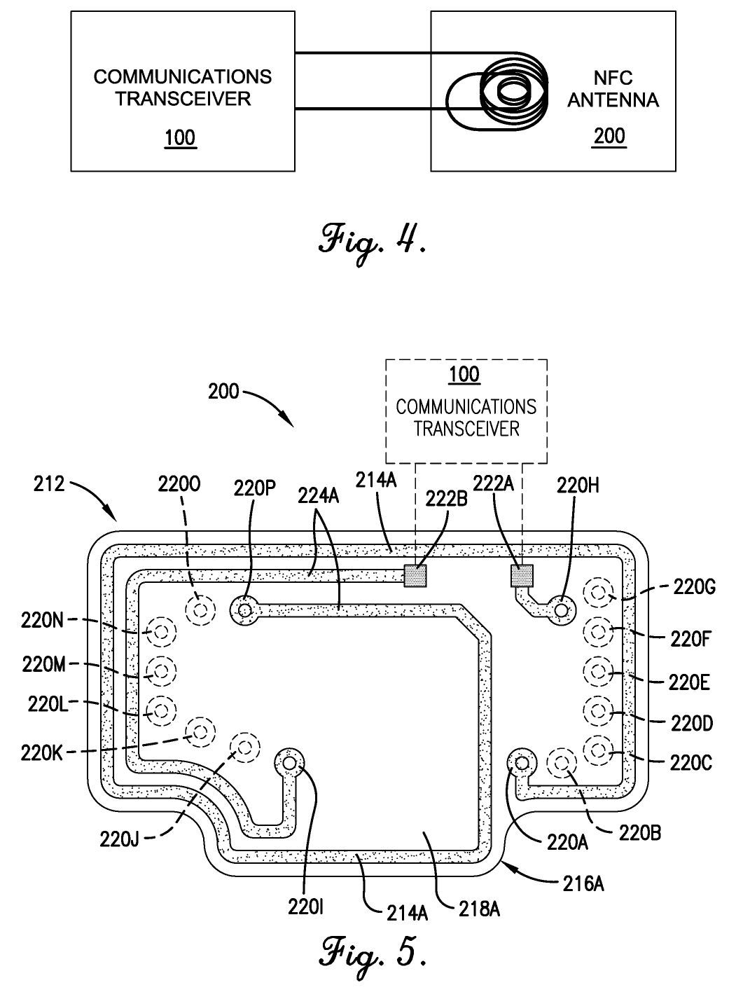

Another embodiment of the NFC antenna 200 is shown in FIGS. 4, 5, and 6A-6H. The NFC antenna 200 is an inductive dual coil antenna that transmits and receives radio frequency (RF) wireless signals in a similar, or identical, fashion as the NFC antenna 10. A typical usage scenario is shown schematically in FIG. 4 and involves the NFC antenna 200 being electrically connected to the communications transceiver 100.

The NFC antenna 200 broadly comprises a multi-layer circuit substrate 212, a plurality of outer antenna segments 214, and a plurality of inner antenna segments 224.

The circuit substrate 212 includes a plurality of spaced-apart (electrically) conductive layers 216, a plurality of spaced-apart (electrically) insulating layers 218, and a plurality of vias 220, each of which is substantially similar to, or the same as, the like-named components described above. An exemplary circuit substrate 212 includes eight (8) conductive layers 216A, 216B, 216C, 216D, 216E, 216F, 216G, 216H and seven (7) insulating layers 218A, 218B, 218C, 218D, 218E, 218F, 218G which are interleaved to form a of electrically conductive layers 216 and electrically insulating layers 218. Given that the NFC antenna 200 includes a plurality of outer antenna segments 214 and a plurality of inner antenna segments 224, exemplary embodiments include sixteen (16) vias 220A, 220B, 220C, 220D, 220E, 220F, 220G, 220H, 220I, 220J, 220K, 220L, 220M, 220N, 220O, 220P that electrically connect or electrically couple the plurality of outer antenna segments 214 and the plurality of inner antenna segments 224.

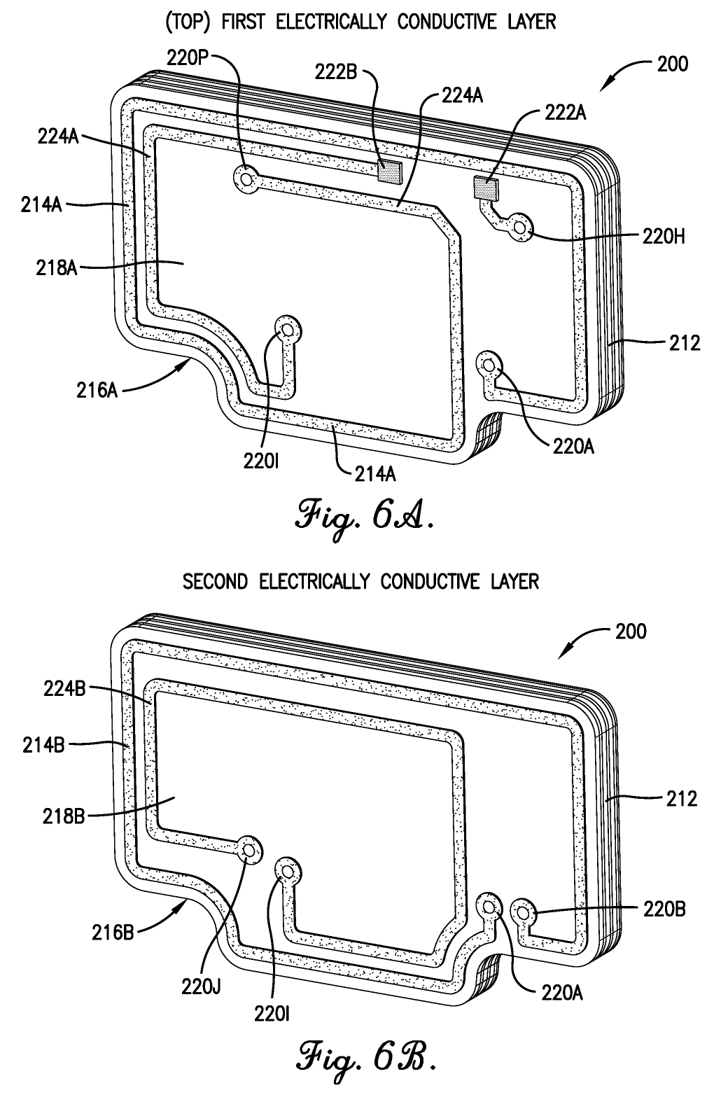

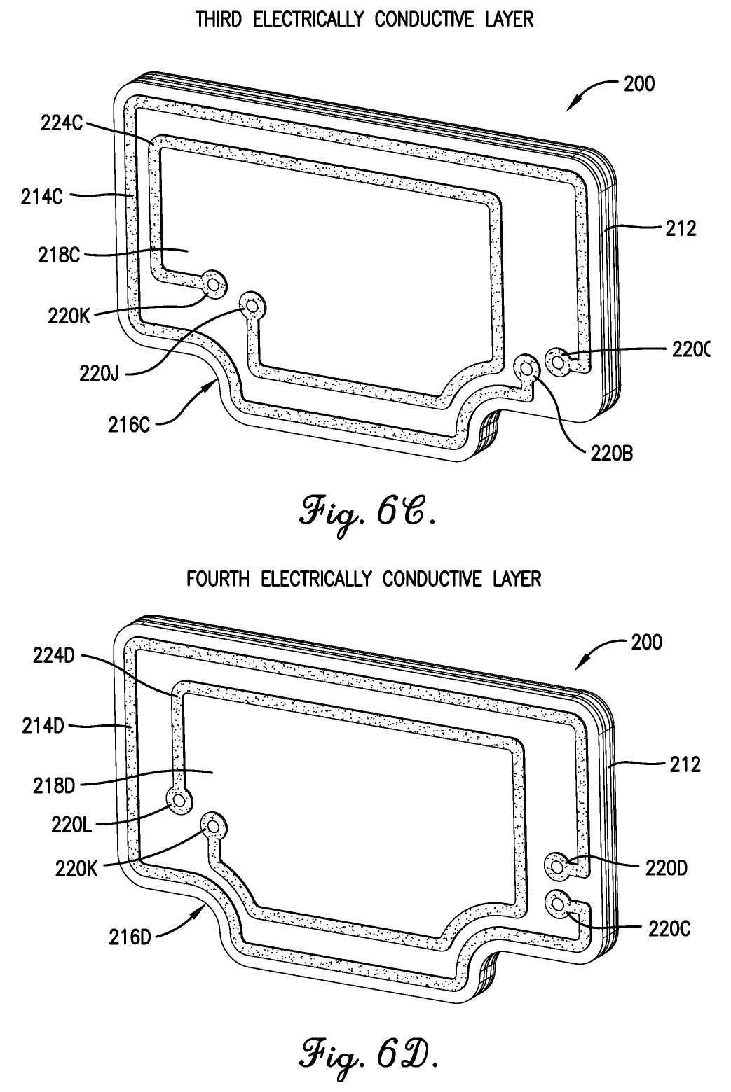

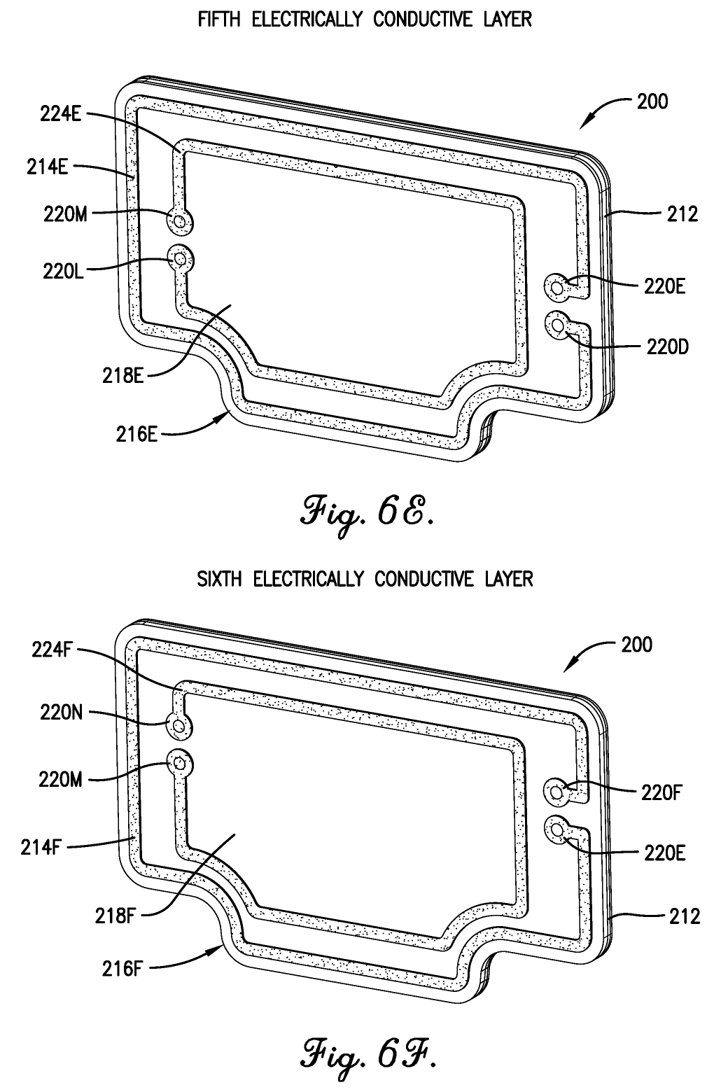

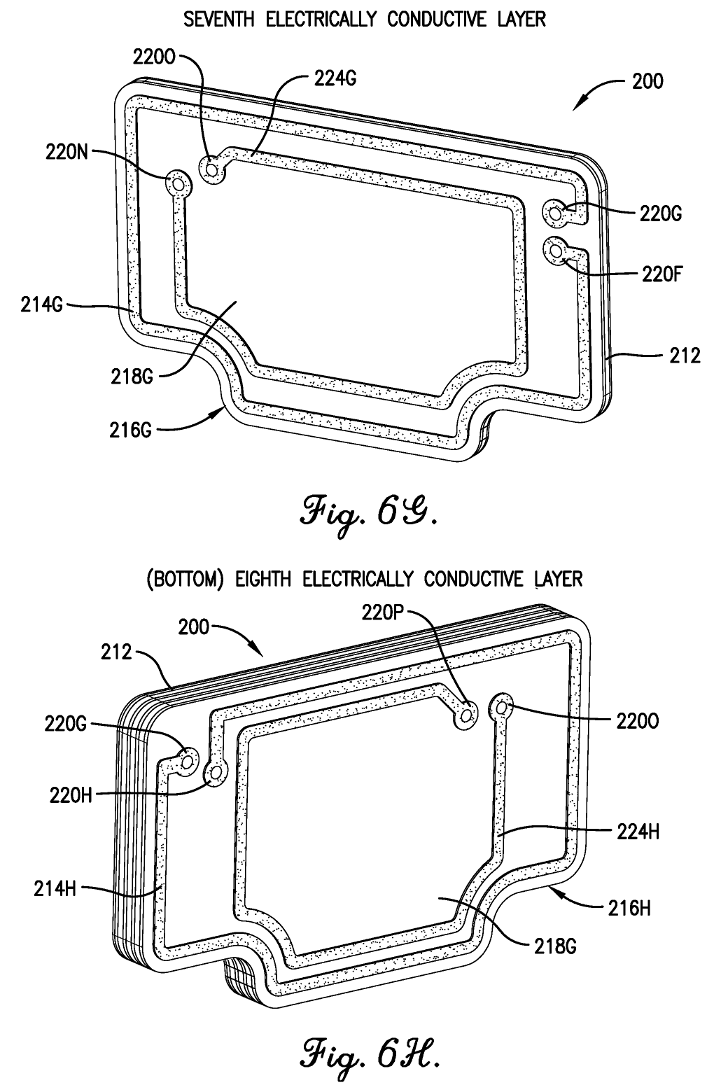

Exemplary embodiments of the NFC antenna 200 include eight (8) outer antenna segments 214A, 214B, 214C, 214D, 214E, 214F, 214G, 214H which are substantially similar to, or the same as, the antenna segments 14A, 14B, 14C, 14D, 14E, 14F, 14G, 14H, respectively, described above for NFC antenna 10. Accordingly, the outer antenna segments 214 include a first outer antenna segment 214A on a first conductive layer 216A, a second outer antenna segment 214B on a second conductive layer 216B, and so forth, with each successive outer antenna segment 214 on a successive conductive layer 216 through an eighth outer antenna segment 214H on an eighth conductive layer 216H. In embodiments, each outer antenna segment 214A-214H is of a substantially equal length. In other embodiments, each outer antenna segment 214A-214H has a different length. As shown in FIGS. 5 and 6A-6H, each outer antenna segment 214 may have a substantially equal length and is generally positioned closer to a perimeter, or the edges, of the conductive layers 216 of the circuit substrate 212 than the inner antenna segment 224 on the same conductive layer 216.

Each outer antenna segment 214 is electrically connected to or electrically coupled with its successive outer antenna segment 214 through a respective one of the vias 220. For example, the first outer antenna segment 214A is electrically connected to the second outer antenna segment 214B through the first via 220A, the second outer antenna segment 214B is electrically connected to the third outer antenna segment 214C through the second via 220B, and so forth, with successive outer antenna segments 214 including the seventh outer antenna segment 214G being electrically connected to the eighth outer antenna segment 214H through the seventh via 220G.

Similar to the outer antenna segments 214, exemplary embodiments of the NFC antenna 200 include eight (8) inner antenna segments 224A, 224B, 224C, 224D, 224E, 224F, 224G, 224H, with each being formed on a respective one of the conductive layers 216. Accordingly, the inner antenna segments 224 include a first inner antenna segment 224A on a first conductive layer 216A, a second inner antenna segment 224B on a second conductive layer 216B, and so forth, with each successive inner antenna segment 224 on a successive conductive layer 216 through an eighth inner antenna segment 224H on an eighth inner conductive layer 216H. In embodiments, each outer antenna segment 214A-214H is of a substantially equal length. In other embodiments, each outer antenna segment 214A-214H has a different length. As shown in FIGS. 5 and 6A-6H, each inner antenna segment 224 may have a substantially equal length and is generally positioned closer to the center of the conductive layers 216 than the outer antenna segment 214 on the same conductive layer 216.

Each inner antenna segment 224 is electrically connected to or electrically coupled with its successive inner antenna segment 224 through a respective one of the vias 220. For example, the first inner antenna segment 224A is electrically connected to the second inner antenna segment 224B through the ninth via 220I, the second outer antenna segment 214B is electrically connected to the third outer antenna segment 214C through the tenth via 220J, and so forth, with successive inner antenna segments 224 including the seventh outer antenna segment 214G being electrically connected to the eighth outer antenna segment 214H through the fifteenth via 220O.

Referring to FIG. 4, the outer coil and the inner coil each have a first terminal and a second terminal, wherein the second terminal of the outer coil is electrically connected to the first terminal of the inner coil to form a longer, continuous coil. Referring to FIGS. 5 and 6A, the electrical connection between the outer coil and the inner coil is made on the first conductive layer 216A, wherein the first outer antenna segment 214A is electrically connected to the first inner antenna segment 224A. Typically, the outer coil is electrically connected to inner coil such that electric current flows through the two coils in the same direction. For example, electric current may flow through the respective outer antenna segment 214 on each conductive layer 216 and through the respective inner antenna segment 224 on each conductive layer 216 in a clockwise direction. Alternatively, electric current may flow through the respective outer antenna segment 214 on each conductive layer 216 and through the respective inner antenna segment 224 on each conductive layer 216 in a counterclockwise direction. In other embodiments, the outer coil may be electrically connected to inner coil such that electric current flows through the two coils in opposing directions (without the coils cancelling each other). For example, electric current may flow through the respective outer antenna segment 214 on each conductive layer 216 in a clockwise direction and through the respective inner antenna segment 224 on each conductive layer 216 in a counterclockwise direction. Alternatively, electric current may flow through the respective outer antenna segment 214 on each conductive layer 216 in a counterclockwise direction and through the respective inner antenna segment 224 on each conductive layer 216 in a clockwise direction.

Referring to FIG. 5, a plan view of the NFC antenna 200 is shown, illustrating the first outer antenna segment 214A and the first inner antenna segment 224A positioned on the (top) first insulating layer 218A. Also shown are the first through the eighth vias 220A-220H that are associated with the outer antenna segments 214 and the ninth through the sixteenth vias 220I, 220J, 220K, 220L, 220M, 220N, 220O, 220P that are associated with the inner antenna segments 224. The second through the seventh vias 220B, 220C, 220D, 220E, 220F, 220G and the tenth through the fifteenth vias 220J, 220K, 220L, 220M, 220N, 220O are shown in dashed lines to indicate their position within the circuit substrate 212 – given that they may be implemented as internal vias that are not visible from the upper surface of the first insulating layer 218A. In addition, the NFC antenna 200 includes a first terminal 222A and a second terminal 222B that provide contacts for the NFC antenna 200 to be electrically connected to other components, such as a communications transceiver 100, as shown in FIG. 5. The first terminal 222A is electrically connected to the eighth via 220H, and the second terminal 222B is electrically connected to the ninth via 220I. The plurality of outer antenna segments 214 and inner antenna segments 224 between the first terminal 222A and the second terminal 222B are electrically connected and electrically coupled through a plurality of vias 220, such as vias 220A-220P, within the multi-layer circuit substrate 12. The first terminal 222A and the second terminal 222B are typically located adjacent to the edge or perimeter of the first conductive layer 216A, which may enable more ease of electrically connecting or electrically coupling the NFC antenna 200 with other components, such as a communications transceiver 100, through a cable, electrical pin header connectors, a socket connector, or the like, or combinations thereof.

Referring to FIGS. 6A-6H, a perspective view of each of the conductive layers 216 and the respective associated outer antenna segment 214 and inner antenna segment 224 is shown. Referring to FIG. 6A, the first outer antenna segment 214A and the first inner antenna segment 224A on the first conductive layer 216A (that is positioned above the upper surface of the first insulating layer 218A) are shown. A first end of the first outer antenna segment 214A is electrically connected to the first via 220A. The first inner antenna segment 224A on the first conductive layer 216A is formed by a combination of two separate traces. A first end of a first trace of the first inner antenna segment 224A is electrically connected to the second terminal 222B, and a second end of the first trace is electrically connected to the ninth via 220I. A first end of a second trace of the first inner antenna segment 224A is electrically connected to the sixteenth via 220P, and a second end of the second trace is electrically connected to a second end of the first outer antenna segment 214A.

Similar to the plurality of vias 20 discussed above for the embodiments shown in FIGS. 1-3H, each via 220 provides electrical connection from or electrical coupling between one or more components, signal traces, or electric power or ground planes on a respective one of the conductive layers 216 to one or more components, signal traces, or electric power or ground planes on one or more of the other conductive layers 216. Each via 220 consists of or includes electrically conductive material (metals and/or metal alloys) and is positioned within and passes through an opening in one or more of the insulating layers 218 to provide an electrical connection from or electrical coupling between two signal traces on positioned on separated conductive layers 216. The vias 220 may include blind vias, buried vias, or through substrate vias.

Referring to FIG. 6B, the second outer antenna segment 214B on the second conductive layer 216B (that is between the upper surface of the second insulating layer 218B and the lower surface of the first insulating layer 218A) is shown. A first end of the second outer antenna segment 214B is electrically connected to the first via 220A, and a second end is electrically connected to the second via 220B. The first via 220A passes through the first insulating layer 218A and electrically couples the first end of the first outer antenna segment 214A with the first end of the second outer antenna segment 214B. Also shown is the second inner antenna segment 224B. A first end of the second inner antenna segment 224B is electrically connected to the ninth via 220I, and a second end is electrically connected to the tenth via 220J. Accordingly, the first outer antenna segment 214A is electrically connected to and electrically coupled with the second outer antenna segment 214B through the first via 220A. Similarly, the first inner antenna segment 224A is electrically connected to and electrically coupled with the second inner antenna segment 224B through the ninth via 220I.

Referring to FIG. 6C, the third outer antenna segment 214C on the third conductive layer 216C (that is between the upper surface of the third insulating layer 218C and the lower surface of the second insulating layer 218B) is shown. A first end of the third outer antenna segment 214C is electrically connected to the second via 220B, and a second end is electrically connected to the third via 220C. The second via 220B passes through the second insulating layer 218B and electrically couples the first end of the second outer antenna segment 214B with the first end of the third outer antenna segment 214C. Also shown is the third inner antenna segment 224C. A first end of the third inner antenna segment 224C is electrically connected to the tenth via 220J, and a second end is electrically connected to the eleventh via 220K. Accordingly, the second outer antenna segment 214B is electrically connected to and electrically coupled with the third outer antenna segment 214C through the second via 220B. Similarly, the second inner antenna segment 224B is electrically connected to and electrically coupled with the third inner antenna segment 224C through the tenth via 220J.

Referring to FIGS. 6D, 6E, 6F, and 6G, the fourth outer antenna segment 214D and the fourth inner antenna segment 224D on the fourth conductive layer 216D, the fifth outer antenna segment 214E and the fifth inner antenna segment 224E on the fifth conductive layer 216E, the sixth outer antenna segment 214F and the sixth inner antenna segment 224F on the sixth conductive layer 216F, and the seventh outer antenna segment 214G and the seventh inner antenna segment 224G on the seventh conductive layer 216G, respectively, are shown. As discussed above for the first outer antenna segment 214A, the second outer antenna segment 214B and the third outer antenna segment 214C, a first end of each outer antenna segment 214 (the fourth outer antenna segment 214D, the fifth outer antenna segment 214E, the sixth outer antenna segment 214F and the seventh outer antenna segment 214G) is electrically connected to a respective first one of the vias 220 and a second end is electrically connected to a respective second one of the vias 220 such that the first outer antenna segment 214A is electrically coupled with the seventh outer antenna segment 214G. As discussed above for the first inner antenna segment 224A, the second inner antenna segment 224B and the third inner antenna segment 224C, a first end of each inner antenna segment 224 (the fourth inner antenna segment 224D, the fifth inner antenna segment 224E, the sixth inner antenna segment 224F and the seventh inner antenna segment 224G) is electrically connected to a respective third one of the vias 220 and a second end is electrically connected to a respective fourth one of the vias 220 such that the first inner antenna segment 224A is electrically coupled with the seventh inner antenna segment 224G.

Referring to FIG. 6H, the eighth outer antenna segment 214H and the eighth inner antenna segment 224H on the eighth conductive layer 216H (positioned on the lower surface of the seventh insulating layer 218G) is shown. A first end of the eighth outer antenna segment 214H is electrically connected to the seventh via 220G, and a second end is electrically connected to the eighth via 220H, which extends up to the first conductive layer 216A. A first end of the eighth inner antenna segment 224H is electrically connected to the fifteenth via 220O, and a second end is electrically connected to the sixteenth via 220P, which also extends up to the first conductive layer 216A.

Each outer antenna segment 214 generally extends along a perimeter, or the edges, of the insulating layers 218 of the circuit substrate 212. Each inner antenna segment 224 generally extends within an inner boundary of the outer antenna segment 214 on the same conductive layer 216. In addition, the outer antenna segments 214 in combination with the vias 220A, 220B, 220C, 220D, 220E, 220F, 220G, 220H form a first, outer coil portion of the NFC antenna 200. Additionally, the inner antenna segments 224 in combination with the vias 220I, 220J, 220K, 220L, 220M, 220N, 220O, 220P form a second, inner coil portion of the NFC antenna 200.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A near field communications (NFC) antenna comprising:
a multi-layer circuit substrate including
a plurality of spaced apart electrically conductive layers each formed from an electrically conductive material, and
a plurality of vias each formed from an electrically conductive material and electrically connecting a respective one of the electrically conductive layers to one or more other electrically conductive layers;
a first antenna segment formed on a first electrically conductive layer;
a second antenna segment formed on a second electrically conductive layer, the second antenna segment electrically connected to the first antenna segment by a first via; and
a third antenna segment formed on a third electrically conductive layer, the third antenna segment electrically connected to the second antenna segment by a second via.

2. The NFC antenna of claim 1, wherein a combination of the antenna segments and the vias forms an inductive coil.

3. The NFC antenna of claim 1, wherein each antenna segment is formed by one or more electrically conductive signal traces on a respective one of the electrically conductive layers.

4. The NFC antenna of claim 3, wherein at least a portion of the one or more signal traces forming each antenna segment extends along the perimeter of the respective one of the electrically conductive layers.

5. The NFC antenna of claim 3, wherein the one or more signal traces forming one of the antenna segments are generally vertically aligned with the one or more signal traces forming the other antenna segments.

6. The NFC antenna of claim 1, wherein the circuit substrate further includes a plurality of spaced apart electrically insulating layers, each electrically insulating layer formed from electrically insulating material and positioned between, and in contact with, a respective pair of adjacent electrically conductive layers, such that the electrically insulating layers and the electrically conductive layers in combination form a stack of electrically conductive layers and electrically insulating layers.

7. The NFC antenna of claim 6, wherein
the circuit substrate includes a first electrically insulating layer and a second electrically insulating layer, each electrically insulating layer having an upper surface and a lower surface, and
the first antenna segment is in contact with the upper surface of the first electrically insulating layer,
the second antenna segment is in contact with the lower surface of the first electrically insulating layer and the upper surface of the second electrically insulating layer, and
the third antenna segment is in contact with the lower surface of the second electrically insulating layer.

8. The NFC antenna of claim 6, wherein each antenna segment has a general loop shape and includes a first end and a second, opposing end, such that the first end is positioned on a respective one of the electrically insulating layers adjacent to the second end.

9. The NFC antenna of claim 1, wherein the first antenna segment and the third antenna segment are each configured to electrically connect to a communications component.

10. A near field communications (NFC) antenna comprising:
a multi-layer circuit substrate including a plurality of spaced apart electrically conductive layers each formed from an electrically conductive material;
a plurality of outer antenna segments electrically connected to one another, each outer antenna segment formed on a respective one of the electrically conductive layers and having a first perimeter or circumference; and
a plurality of inner antenna segments electrically connected to one another, each inner antenna segment formed on a respective one of the electrically conductive layers and having a second perimeter or circumference which is less than the first perimeter or circumference.

11. The NFC antenna of claim 10, wherein
the multi-layer circuit substrate includes a plurality of vias each formed from an electrically conductive material and electrically connecting a respective one of the electrically conductive layers to one or more other electrically conductive layers;
the outer antenna segments include
a first outer antenna segment on a first electrically conductive layer,
a second outer antenna segment on a second electrically conductive layer, the second antenna segment electrically connected to the first antenna segment by a first via, and
a third outer antenna segment on a third electrically conductive layer, the third antenna segment electrically connected to the second antenna segment by a second via; and
the inner antenna segments include
a first inner antenna segment on the first electrically conductive layer,
a second inner antenna segment on the second electrically conductive layer, the second inner antenna segment electrically connected to the first inner antenna segment by a third via, and
a third inner antenna segment on the third electrically conductive layer, the third inner antenna segment electrically connected to the second inner antenna segment by a fourth via.

12. The NFC antenna of claim 11, wherein a combination of the outer antenna segments and the first and second vias forms a first inductive coil, and a combination of the inner antenna segments and the third and fourth vias forms a second inductive coil.

13. The NFC antenna of claim 11, wherein the first outer antenna segment, the third outer antenna segment, the first inner antenna segment, and the third inner antenna segment are each configured to electrically connect to a communications component.

14. The NFC antenna of claim 10, wherein each outer antenna segment is formed by one or more electrically conductive signal traces on a respective one of the electrically conductive layers, and each inner antenna segment is formed by one or more electrically conductive signal traces on a respective one of the electrically conductive layers.

15. The NFC antenna of claim 14, wherein
at least a portion of the one or more signal traces forming each outer antenna segment extends along the perimeter of the respective one of the electrically conductive layers, and
at least a portion of the one or more signal traces forming each inner antenna segment is positioned inward from the one or more signal traces forming the outer antenna segment on a respective one of the electrically conductive layers.

16. The NFC antenna of claim 14, wherein
the one or more signal traces forming one of the outer antenna segments are generally vertically aligned with the one or more signal traces forming the other outer antenna segments, and
the one or more signal traces forming one of the inner antenna segments are generally vertically aligned with the one or more signal traces forming the inner outer antenna segments.

17. The NFC antenna of claim 10, wherein the circuit substrate further includes a plurality of spaced apart electrically insulating layers, each electrically insulating layer formed from electrically insulating material and positioned between, and in contact with, a respective pair of adjacent electrically conductive layers, such that the electrically insulating layers and the electrically conductive layers in combination form a stack of electrically conductive layers and electrically insulating layers.

18. The NFC antenna of claim 17, wherein
the circuit substrate includes a first electrically insulating layer and a second electrically insulating layer, each electrically insulating layer having an upper surface and a lower surface, and
the first outer antenna segment and the first inner antenna segment are each in contact with the upper surface of the first electrically insulating layer,
the second outer antenna segment and the second inner antenna segment are each in contact with the lower surface of the first electrically insulating layer and the upper surface of the second electrically insulating layer, and
the third outer antenna segment and the third inner antenna segment are each in contact with the lower surface of the second electrically insulating layer.

19. The NFC antenna of claim 17, wherein
each outer antenna segment has a general loop shape and includes a first end and a second, opposing end, such that the first end is positioned on a respective one of the electrically insulating layers adjacent to the second end, and
each inner antenna segment has a general loop shape and includes a first end and a second, opposing end, such that the first end is positioned on a respective one of the electrically insulating layers adjacent to the second end.

20. A near field communications (NFC) antenna comprising:
a multi-layer circuit substrate including
a plurality of spaced apart electrically conductive layers each formed from an electrically conductive material,
a plurality of spaced apart electrically insulating layers each formed from an electrically insulating material, the electrically insulating layers being interleaved with the electrically conductive layers, and
a plurality of vias each formed from an electrically conductive material and electrically connecting a respective one of the electrically conductive layers to one or more other electrically conductive layers; and
a plurality of antenna segments, each antenna segment
formed on a respective one of the electrically conductive layers,
extending along a perimeter of the circuit substrate, and
electrically connected to another antenna segment on another one of the electrically conductive layers through a respective one of the vias.
